(19) United States
(12) Patent Application Publication
(10) Pub. No.: US 2025/0331091 A1
(43) Pub. Date: Oct. 23, 2025

(54) X-Ray Control Method, System, and CT Apparatus

(71) Applicant: Yofo (Hefei) Medical Technology Co., Ltd., Hefei (CN)

(72) Inventors: Lei ZHU, Hefei (CN); Junqi MA, Hefei (CN); Wenrui YU, Hefei (CN); Ran XU, Hefei (CN); Xianjin GUAN, Hefei (CN); Wei ZHANG, Hefei (CN)

(21) Appl. No.: 19/252,208

(22) Filed: Jun. 27, 2025

(51) Int. Cl. H05G 1/46; H05G 1/20; H05G 1/32

(52) U.S. Cl. CPC H05G 1/46; H05G 1/20; H05G 1/32

(57) ABSTRACT

The present disclosure provides a method, system, and apparatus for controlling X-rays. The method of the present disclosure includes: obtaining control parameters in response to an X-ray control request from a CT control unit, wherein the control parameters include at least one tank identifier, at least one voltage parameter, at least one current parameter, and at least one exposure timing; controlling, based on the tank identifier and the voltage parameter, at least one high frequency inverter of a high frequency inverter assembly to output a high frequency voltage to a corresponding tank; and controlling, based on the tank identifier and the current parameter, at least one filament power supply of a filament power supply assembly to output a filament current to the corresponding tank, thereby controlling the tank to perform an X-ray exposure task according to the exposure timing.

### TECHNICAL FIELD

The present disclosure relates to an X-ray control method, system, and CT apparatus.

### BACKGROUND

Computed Tomography (CT) is an imaging technique that uses X-rays to obtain images of an object from multiple angles and reconstructs three-dimensional images through computer algorithms. CT apparatuses are widely used in medical diagnostics (e.g., tumor detection, fracture analysis) and industrial inspection. The CT apparatuses acquire multi-angle projection data by rotating an X-ray source and a detector, and generates cross-sectional images through computer processing. Cone Beam CT (CBCT), as an improvement over a conventional CT, is typically suitable for specific scenarios, such as scanning localized areas like the oral cavity or neck.

In existing CBCT apparatuses, in addition to the traditional single-source, single-detector structure, there are single-source, dual-energy, or multi-energy application structures. Due to the single-source multi-energy structure, a rapid switching of output tube voltages is required. This imposes high demands on control systems and easily causes fluctuations of the tube current, adversely affecting imaging quality. Another approach to the dual-energy imaging involves scanning multiple rotations, with different tube voltages for each rotation. While the approach achieves a stable multi-energy imaging, it at least doubles the radiation dose, which is detrimental to human health. Alternatively, using multiple independent X-ray sources for the dual-energy or multi-energy control ensures a precise and stable control but significantly increases equipment costs and overall volume.

### SUMMARY

The present disclosure provides an X-ray control method, system, and CT apparatus.

A first aspect of the present disclosure provides an X-ray control method executed by an X-ray source microcontroller in a CT apparatus, comprising: obtaining control parameters in response to an X-ray control request from a CT control unit, wherein the control parameters comprise at least one tank identifier, at least one voltage parameter, at least one current parameter, and at least one exposure timing; controlling, based on the tank identifier and the voltage parameter, at least one high frequency inverter of a high frequency inverter assembly to output a high frequency voltage to a corresponding tank of a plurality of tanks filled with insulating oil; and controlling, based on the tank identifier and the current parameter, at least one filament power supply of a filament power supply assembly to output a filament current to the corresponding tank, thereby controlling the corresponding tank to perform an X-ray exposure task according to the exposure timing.

The solution proposed by the present disclosure ensures a precise scanning and an accurate imaging without additional costs. Multiple filament power supplies and high frequency inverters are integrated into a single module, resulting in a smaller volume. Each tank is equipped with an independent high frequency inverter and filament power supply, allowing each tank to operate at its own voltage without requiring voltage switching. Multiple high frequency inverters are integrated into a high frequency inverter assembly, multiple filament power supplies are integrated into a filament power supply assembly, and multiple tanks are integrated into a tank assembly. These assemblies are further integrated into a single board module, effectively reducing the overall volume.

In at least one embodiment of the present disclosure, obtaining the control parameters in response to the X-ray control request from the CT control unit comprises: obtaining a first tank identifier and a second tank identifier in response to the X-ray control request; and determining a first voltage parameter and a first current parameter corresponding to the first tank identifier, and determining a second voltage parameter and a second current parameter corresponding to the second tank identifier, wherein the first voltage parameter and the first current parameter are used to control an output of a first tank, and the second voltage parameter and the second current parameter are used to control an output of a second tank.

In at least one embodiment of the present disclosure, when the first voltage parameter is different from the second voltage parameter, the method further comprises: controlling a first high frequency inverter to generate a first tube voltage based on the first voltage parameter, and controlling a second high frequency inverter to generate a second tube voltage based on the second voltage parameter.

In at least one embodiment of the present disclosure, when the first current parameter is different from the second current parameter, the method further comprises: controlling a first filament power supply to generate a first tube current based on the first current parameter, and controlling a second filament power supply to generate a second tube current based on the second current parameter.

In at least one embodiment of the present disclosure, in response to a voltage change request for the first tank and/or the second tank, the method includes controlling an increase or decrease in the first tube voltage while maintaining the first tube current constant, and controlling an increase or decrease in the second tube voltage while maintaining the second tube current constant.

In at least one embodiment of the present disclosure, prior to obtaining the first tank identifier and the second tank identifier, further comprising: transmitting a preparation signal to the first high frequency inverter, the second high frequency inverter, the first filament power supply, and the second filament power supply, respectively; and transmitting a preparation completion signal to the CT control unit after a preparation is completed.

In at least one embodiment of the present disclosure, controlling the corresponding tank to perform the X-ray exposure task comprises: when the exposure timing is in a pulse signal mode, dynamically adjusting a duty cycle to control output voltages of the first high frequency inverter and the second high frequency inverter, and performing the X-ray exposure task using the output voltages; and when the exposure timing is in a continuous signal mode, using a fixed duty cycle to control the output voltages of the first high frequency inverter and the second high frequency inverter, and performing the X-ray exposure task using the output voltages.

In at least one embodiment of the present disclosure, the method further comprising: receiving the first tube voltage and the first tube current from the first tank, and receiving the second tube voltage and the second tube current from the second tank; and monitoring, based on a voltage threshold, whether the first tube voltage and the second tube voltage are faulty, and monitoring, based on a current threshold, whether the first tube current and the second tube current are faulty.

In at least one embodiment of the present disclosure, the control parameters include N tank identifiers, where N≥2, the N tank identifiers correspond respectively to one tank of the plurality of tanks, and the N tank identifiers correspond one-to-one with respective voltage parameters and respective current parameters.

A second aspect of the present disclosure provides An X-ray control system, comprising: a power supply module comprising a high frequency inverter assembly and a filament power supply assembly, wherein the high frequency inverter assembly and the filament power supply assembly are electrically connected to a power supply, the high frequency inverter assembly comprises a plurality of high frequency inverters that are independently operating, and the filament power supply assembly comprises a plurality of filament power supplies that are independently operating; a tank assembly comprising a plurality of tanks that are filled with insulating oil and are independently operating, wherein each of the plurality of tanks is configured to generate X-rays under a control of a pair of one high frequency inverter and one filament power supply; and an X-ray source microcontroller configured to: receive control parameters in response to an X-ray control request, wherein the control parameters comprise at least one tank identifier, at least one voltage parameter, at least one current parameter, and at least one exposure timing; control, based on the tank identifier and the voltage parameter, at least one high frequency inverter of the high frequency inverter assembly to output a high frequency voltage to a tank of the plurality of tanks, and control, based on the tank identifier and the current parameter, at least one filament power supply of the filament power supply assembly to output a filament current to the tank, thereby controlling the tank to perform an X-ray exposure task according to the exposure timing.

Based on the disclosed solution, precise scanning and accurate imaging are achieved without additional equipment costs. Multiple filament power supplies and high frequency inverters are integrated into a single module, resulting in a smaller volume. Each tank is equipped with an independent high frequency inverter and filament power supply, allowing each tank to operate at its own voltage without requiring voltage switching. Multiple high frequency inverters are integrated into a high frequency inverter assembly, multiple filament power supplies are integrated into a filament power supply assembly, and multiple tanks are integrated into a tank assembly. These assemblies are further integrated into a single board module, effectively reducing the overall volume.

In at least one embodiment of the present disclosure, the X-ray control system further includes a CT control unit configured to generate the X-ray control request in response to a control instruction from a user and transmit the X-ray control request to the X-ray source microcontroller.

In at least one embodiment of the present disclosure, the X-ray control system further includes a detector configured to receive the X-rays generated by the tank assembly and convert the X-rays into grayscale values for generating a visible image.

In at least one embodiment of the present disclosure, the high frequency inverter assembly includes a plurality of independent high frequency inverters, each high frequency inverter being connected to the power supply to receive an input voltage and connected to the X-ray source microcontroller to receive a voltage control signal.

In at least one embodiment of the present disclosure, the filament power supply assembly includes a plurality of independent filament power supplies, each filament power supply being connected to the power supply to receive an input voltage and connected to the X-ray source microcontroller to receive a current control signal.

In at least one embodiment of the present disclosure, the tank assembly includes a plurality of tanks, each tank comprising: a high-voltage transformer configured to generate a tube voltage after receiving the voltage control signal; a filament isolation transformer configured to generate a tube current after receiving the current control signal; a voltage multiplier rectifier circuit configured to convert a high-voltage, high frequency AC voltage into positive and negative high voltages supplied to an X-ray tube; a sampling circuit configured to collect the positive and negative high voltages and the tube current; and the X-ray tube configured to generate X-rays.

In at least one embodiment of the present disclosure, the plurality of tanks are arranged around the detector, with X-ray emission angles of the plurality of tanks directed toward the detector.

In at least one embodiment of the present disclosure, the power supply, the filament power supply assembly, the high frequency inverter assembly, the tank assembly, and the X-ray source microcontroller are integrated into a single module.

In at least one embodiment of the present disclosure, the X-ray source microcontroller is further configured to receive the tube voltage and the tube current from each of the plurality of tanks and monitor whether the X-ray control system is faulty based on the tube voltage and the tube current.

In at least one embodiment of the present disclosure, the X-ray source microcontroller is further configured to perform closed-loop processing of the tube voltage and the tube current to output a stable tube voltage and a stable tube current.

A third aspect of the present disclosure provides a CT apparatus comprising the X-ray control system described in the second aspect.

### BRIEF DESCRIPTION OF THE DRAWINGS

The drawings illustrate exemplary embodiments of the present disclosure and, together with the description, serve to explain the principles of the present disclosure. These drawings are included to provide a further understanding of the present disclosure and are incorporated into and constitute a part of this specification.

FIG. 1 is a schematic structural diagram of an X-ray control system according to an embodiment of the present disclosure.

FIG. 2 is a schematic structural diagram of a high frequency inverter assembly according to an embodiment of the present disclosure.

FIG. 3 is a schematic structural diagram of a filament power supply assembly according to an embodiment of the present disclosure.

FIG. 4 is a schematic structural diagram of a tank assembly according to an embodiment of the present disclosure.

FIG. 5 is a schematic diagram of an internal structure of a tank according to an embodiment of the present disclosure.

FIG. 6 is a schematic diagram illustrating a positional relationship between tanks and a detector according to an embodiment of the present disclosure.

FIG. 7 is a flowchart of an X-ray control method according to an embodiment of the present disclosure.

FIG. 8 is a schematic diagram of a voltage and current control process according to an embodiment of the present disclosure.

FIG. 9 is a flowchart from preparation to execution of control according to an embodiment of the present disclosure.

FIG. 10 is a flowchart of an X-ray exposure task execution mode according to an embodiment of the present disclosure.

FIG. 11 is a timing diagram of a pulse signal mode according to an embodiment of the present disclosure.

FIG. 12 is a timing diagram of a continuous signal mode according to an embodiment of the present disclosure.

FIG. 13 is a schematic structural diagram of a power supply system according to an embodiment of the present disclosure.

### DETAILED DESCRIPTION

The present disclosure is further described in detail below with reference to the drawings and embodiments. It is to be understood that the specific embodiments described herein are merely illustrative of the relevant content and are not intended to limit the present disclosure. Additionally, for ease of description, only portions relevant to the present disclosure are shown in the drawings.

It should be noted that, in the absence of conflict, the embodiments and features of the embodiments in the present disclosure may be combined with each other. The technical solutions of the present disclosure will be described in detail below with reference to the drawings and embodiments.

To achieve multi-energy spectrum output, there are two structures in existing CBCT apparatuses. In the first structure, a single controller controls one X-ray tube and one power supply. In the second structure, multiple controllers independently control multiple X-ray tubes, each powered by separate power supplies. Both structures have certain drawbacks. The first structure typically uses hot cathode X-ray tubes, where a tube current stability is significantly affected by a tube voltage. Consequently, during dual-voltage switching, the tube current stability is not well, impacting an imaging quality. Additionally, a multi-rotation scanning approach of the first structure for dual-energy or multi-energy imaging achieves the stable tube voltage and the tube current output but increases radiation dose exponentially, which is harmful to human health. The second structure, due to the use of multiple controllers and power supply modules that operate independently, incurs higher costs, larger volume, and more complex control. Therefore, it is necessary to provide an X-ray control solution that is compact, cost-effective, and simple to control.

For clarity and ease of understanding, before describing the technical solution of the present disclosure, the terms used in the embodiments are described as follows:

Computed Tomography (CT) Device: The CT device uses a fan-beam X-ray rotational scanning, covers a wide range, and has a higher radiation dose (approximately several mSv per scan). It is suitable for whole-body examinations, offering a high spatial resolution (sub-millimeter level) and excellent soft tissue contrast, ideal for detailed imaging of body organs.

Cone Beam CT (CBCT) Device: The CBCT device employs a cone-beam X-ray circular scanning, focuses on localized areas (e.g., oral cavity, head, and neck), and significantly reduces radiation dose (approximately 0.02-0.1 mSv per scan, and 1/10 to 1/100 of the CT). It is particularly suitable for radiation-sensitive patients. Spatial resolution is slightly lower (approximately 0.1-0.4 mm), but the CBCT provides clear imaging of hard tissues (e.g., teeth, and bones) with an intuitive three-dimensional reconstruction, facilitating a detailed observation of anatomical structures.

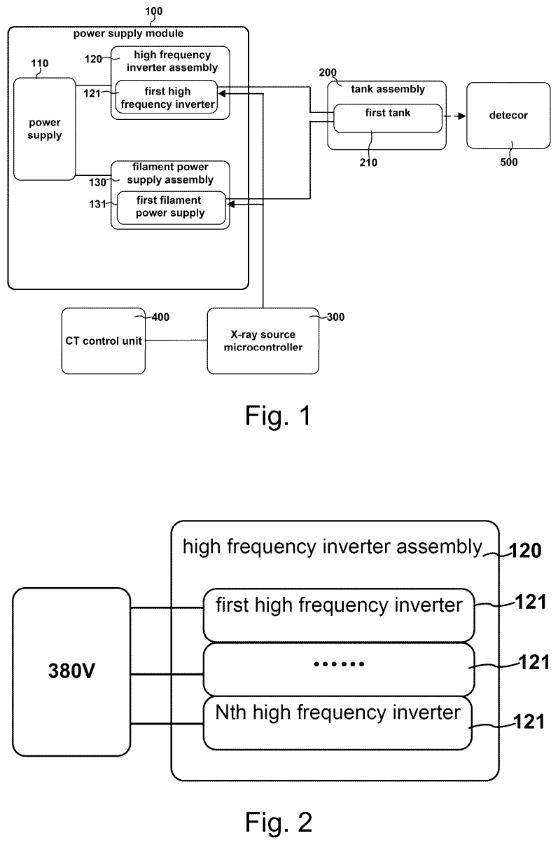

FIG. 1 illustrates a schematic structural diagram of an X-ray control system according to an embodiment of the present disclosure. As shown in FIG. 1, the X-ray control system includes a power supply module 100, a tank assembly 200, and an X-ray source microcontroller 300.

The power supply module 100 includes a high frequency inverter assembly 120 and a filament power supply assembly 130. The high frequency inverter assembly 120 and the filament power supply assembly 130 are electrically connected to a power supply 110. The high frequency inverter assembly 120 includes a plurality of high frequency inverters 121 that are independently operating. The filament power supply assembly 130 includes a plurality of filament power supplies 131 that are independently operating.

The tank assembly 200 includes a plurality of tanks 210 that are independently operating. Each tank 210 is configured to generate X-rays under the control of a pair comprising one high frequency inverter 121 and one filament power supply 131.

The X-ray source microcontroller 300 is connected to the power supply module 100 and the tank assembly 200. The X-ray source microcontroller 300 is configured to receive control parameters in response to an X-ray control request; control, based on a tank identifier and a voltage parameter of the control parameters, at least one high frequency inverter 121 of the high frequency inverter assembly 120 to output a high frequency voltage to a corresponding tank 210; and control, based on the tank identifier and a current parameter in the control parameters, at least one filament power supply 131 of the filament power supply assembly 130 to output a filament current to the corresponding tank 210, thereby controlling the tank to perform an X-ray exposure task according to an exposure timing.

As shown in FIG. 1, the power supply 110, the filament power supply assembly 130, the high frequency inverter assembly 120, the tank assembly 200, and the X-ray source microcontroller 300 are integrated into a single module. The power supply 110 receives electrical energy through a power line. The power supply 110 is electrically connected to the high frequency inverter assembly 120 and the filament power supply assembly 130. The X-ray control system is powered by a single power source and distributes the electrical energy to the high frequency inverter assembly 120 and the filament power supply assembly 130. The high frequency inverter assembly 120 generates a tube voltage, while the filament power supply assembly 130 generates a tube current. Since each X-ray tube has independently controlled tube voltage and tube current during operation, different tube voltages can be easily achieved while maintaining stable tube currents for each X-ray tube, enabling a stable dual-energy switching. The technical solution of the present disclosure eliminates the need for rapid tube voltage switching on a single X-ray tube, as required in single-source dual-energy systems.

The X-ray source microcontroller 300 communicates with a CT control unit 400 via a serial port 422 or a serial port 232. The X-ray source microcontroller 300 receives X-ray control parameters (e.g., tube voltages, tube currents, and exposure timings) from the CT control unit 400 and generates multiple independent drive signals to control independently a first high frequency inverter 121 and a first filament power supply 131. Additionally, through an Analog-to-Digital Converter (ADC) module, the X-ray source microcontroller 300 monitors voltage, current, and temperature signals from each tank 210 in real time. Upon detecting overvoltage, overcurrent, or overtemperature, protective actions are triggered to prevent failures or failure propagations.

It should be noted that, in the present disclosure, the number of high frequency inverters matches the number of filament power supplies and tanks. To facilitate differentiation and control of voltage, current, and tanks, each set of circuits is assigned a tank identifier, which can be used to identify the corresponding high frequency inverter, filament power supply, and tank.

Based on the disclosed solution, the independent power supply and control of each tank 210 through a distributed multi-source architecture eliminate tube current fluctuations caused by a voltage switching in traditional single-source dual-energy CT systems, improving the tube current stability. The single-board integrated design of the high frequency inverter assembly 120 and the filament power supply assembly 130 significantly reduces a system volume and weight, and supports the modular expansion for a dual-energy, tri-energy, or multi-energy spectrum output.

In one or more embodiments of the present disclosure, the X-ray control system further includes a CT control unit 400. The CT control unit 400 is configured to generate an X-ray control request in response to a control instruction from a user and transmit the X-ray control request to the X-ray source microcontroller 300.

As shown in FIG. 1, the CT control unit 400, as the main control unit (MCU) of the X-ray control system, can control both the X-ray source microcontroller 300 and the operating state of a detector 500.

The CT control unit 400, as the core controller of the CT system, receives user-input scan mode instructions (e.g., a bone-soft tissue separation mode, a metal artifact suppression mode, or a quantitative analysis mode) and automatically generates corresponding X-ray control requests based on preset clinical protocols. These control requests include multiple sets of control parameters for X-ray sources, such as voltage parameter (kV) values, current parameter (mA) values, exposure timings, and X-ray on/off states for each tank 210. Additionally, some control parameters include sampling timings, a binning mode (pixel merging mode), and gain adjustment parameters for the detector 500. The generated X-ray control request is transmitted to the X-ray source microcontroller 300 via the serial port 422 or a serial port 232. The X-ray source microcontroller 300 parses the parameters and drives the independent high frequency inverters 121 of the high frequency inverter assembly 120 and the filament power supplies 131 of the filament power supply assembly 130, enabling each tank 210 to output X-rays of different energy spectra as needed.

Through the hierarchical control architecture of the CT control unit and the X-ray source microcontroller 300, the high-precision synchronization (the timing error<1 μs) of the multi-energy spectrum X-ray output and the detector sampling is achieved, significantly reducing image artifacts. The independent parameter configuration capability supports a seamless switching between the dual-energy mode, the tri-energy mode, and the multi-energy spectrum mode, accommodating complex clinical requirements.

In one or more embodiments of the present disclosure, the X-ray control system further includes a detector 500. The detector 500 is configured to receive X-rays generated by the tank assembly 200 and convert the X-rays into grayscale values for generating a visible image.

As shown in FIG. 1, for the control of the detector, the CT control unit 400 is connected to the detector 500 via a synchronization signal line (e.g., a TTL-level trigger line or an optical fiber communication link) to coordinate the operating state of the detector 500 in real time. Specifically, the CT control unit 400 triggers the detector 500 to enter a data acquisition phase based on the exposure start time from the X-ray source microcontroller 300, dynamically adjusting the sampling frequency to match a pulse width or a continuous exposure mode of the X-rays. For dynamic scanning scenarios, the CT control unit 400 compensates for mechanical motion delays between the X-ray source and the detector using preset timing offsets, ensuring that the detector 500 completes a signal integration and digitization during critical phases when the X-rays penetrate the object being scanned. Additionally, based on the dynamic range of the grayscale values fed back by the detector 500, the CT control unit 400 automatically adjusts the gain and offset parameters to prevent signal saturation or under sampling due to intensity variations in multi-energy spectrum X-rays.

In one or more embodiments of the present disclosure, the high frequency inverter assembly 120 includes a plurality of independent high frequency inverters 121. Each high frequency inverter 121 is connected to the power supply 110 to receive an input voltage and is connected to the X-ray source microcontroller 300 to receive a voltage control signal.

FIG. 2 illustrates a schematic structural diagram of the high frequency inverter assembly according to an embodiment of the present disclosure. As shown in FIG. 2, the high frequency inverter assembly 120 includes N (N is an integer greater than or equal to 2) independently operating high frequency inverters 121. Each high frequency inverter 121, for example, may adopt a full-circuit topology, and be capable of converting a high-voltage AC input of 380V from the power supply 110 into a high frequency AC voltage signal. Each high frequency inverter 121 controls its output amplitude and frequency through an independent drive signal to match the tube voltage parameters required by the corresponding tank 210. The high frequency inverters 121 may operate independently and the number of the high frequency inverters 121 may be multiple. Due to the simple circuit structure of the of the high frequency inverters 121, the high frequency inverters 121 may be integrated into a single assembly, resulting in low overall costs and a compact volume despite that the number of the high frequency inverters 121 is multiple.

In one or more embodiments of the present disclosure, the filament power supply assembly 130 includes a plurality of independent filament power supplies 131. Each filament power supply 131 is connected to the power supply 110 to receive an input voltage and is connected to the X-ray source microcontroller 300 to receive a current control signal.

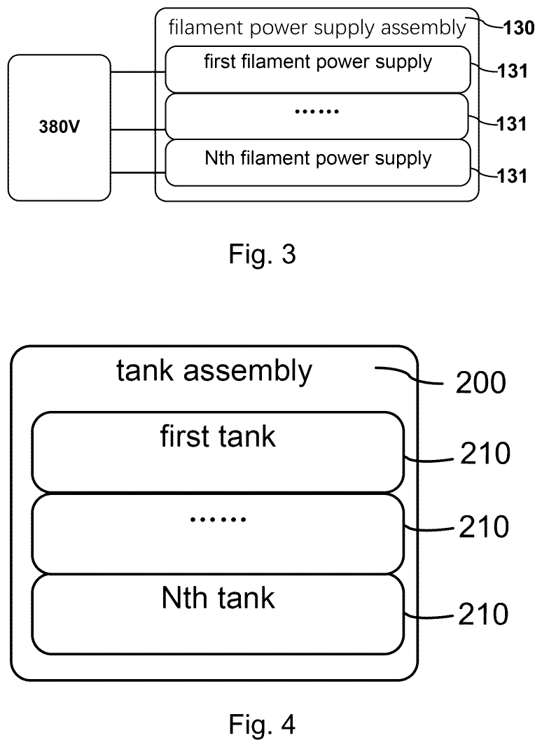

FIG. 3 illustrates a schematic structural diagram of the filament power supply assembly according to an embodiment of the present disclosure. As shown in FIG. 3, the filament power supply assembly 130 includes N (N is an integer greater than or equal to 2) independently operating filament power supplies 131. Each filament power supply 131 employs a closed-loop feedback control circuit, capable of dynamically adjusting output currents based on instructions from the X-ray source microcontroller 300, ensuring that the filament of the X-ray tube in each tank 210 is preheated to a target state, thereby eliminating tube current fluctuations caused by space charge effects. The filament power supplies 131 may operate independently, and the simple circuit structure of the filament power supplies 131 allows integration into a single assembly, maintaining low costs and a compact volume despite that the number of the filament power supplies 131 is multiple.

In one or more embodiments of the present disclosure, the tank assembly 200 includes a plurality of tanks 210. Each tank 210 includes a high-voltage transformer, a filament isolation transformer, a voltage multiplier rectifier circuit, a sampling circuit, and an X-ray tube. The high-voltage transformer generates a high-voltage, high frequency AC voltage upon receiving a high frequency AC voltage signal. The filament isolation transformer generates a tube current indirectly upon receiving a current control signal. The voltage multiplier rectifier circuit converts the high-voltage, high frequency AC voltage into positive and negative high voltages to power the X-ray tube. The sampling circuit collects the positive and negative high voltages and the tube current for closed-loop processing. The X-ray tube generates X-rays.

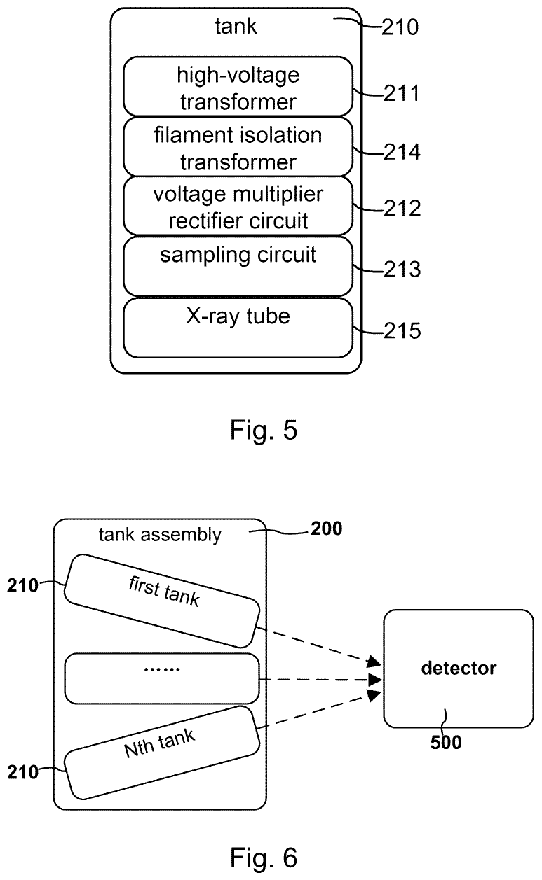

FIG. 4 illustrates a schematic structural diagram of the tank assembly according to an embodiment of the present disclosure. As shown in FIG. 4, the tank assembly 200 includes a plurality of independent tanks 210. FIG. 5 illustrates a schematic structural diagram of the internal structure of a tank according to an embodiment of the present disclosure. As shown in FIG. 5, each tank 210 integrates a high-voltage transformer 211, a voltage multiplier rectifier circuit 212, a sampling circuit 213, a filament isolation transformer 214, an X-ray tube 215, and insulating oil. Each tank 210 has independent voltage and current circuits, capable of generating required X-rays independently. The tanks operate without mutual interference and may generate various X-rays at different power levels, meeting diverse X-ray generation needs.

The primary winding of the high-voltage transformer is connected to the output terminal of the corresponding high frequency inverter 121. The secondary winding of the high-voltage transformer generates the high-voltage electric field required for the X-ray tube via the voltage multiplier rectifier circuit. The filament isolation transformer is connected to the corresponding filament power supply 131, transferring a filament heating current through a magnetic coupling to achieve a high-voltage insulation and a current isolation.

In one or more embodiments of the present disclosure, the plurality of tanks 210 are arranged around the detector 500, with X-ray emission angles of the tanks directed toward the detector 500.

FIG. 6 illustrates a schematic positional relationship between the tanks and the detector according to an embodiment of the present disclosure. As shown in FIG. 6, the solution includes multiple tanks, for example, three tanks. The CT apparatus has three X-ray sources. The dashed lines in FIG. 6 represent X-rays emitted by the tanks, and all X-rays are directed toward the detector.

With more tanks, the relative angular positions of the tanks with respect to the detector 500 should be adjusted, with the detector 500 as the center, to ensure that the X-rays emitted from each tank are accurately directed toward the detector 500. This configuration ensures that the X-rays generated by the X-ray control system with multiple sources are precisely received by the detector 500, enabling the generation of highly accurate images.

In one or more embodiments of the present disclosure, the X-ray source microcontroller 300 is further configured to receive the tube voltage and the tube current from each tank 210 and monitor whether the X-ray control system is faulty based on the tube voltage and the tube current. The X-ray source microcontroller 300 is also configured to perform closed-loop processing of the tube voltage and the tube current to output a stable tube voltage and a stable tube current.

In the X-ray control system of the present disclosure, the X-ray source microcontroller 300 controls the operation of the high frequency inverters and the filament power supplies while receiving the real-time feedback from the tanks on the tube voltage and the tube current which characterize the current state. For example, a voltage threshold may be set, and the relationship between the tube voltage and the voltage threshold may be compared to determine if a voltage fault has occurred in the tank. Similarly, a current threshold can be set, and the relationship between the tube current and the current threshold can be compared to determine if a current fault has occurred in the tank.

The centralized control logic of the X-ray source microcontroller 300 ensures a synchronized exposure of independent components and a precise detector sampling, while a distributed fault monitoring mechanism enhances a system reliability, reducing failure rates.

The closed-loop processing of the tube voltage and the tube current may refer to the use of Proportion Integral (PI) or Proportion Integral Differential (PID) algorithms.

Specifically, the closed-loop processing of the tube voltage involves: based on a set voltage value for the tube voltage and a sampled output voltage value, performing the closed-loop control using the PI algorithm to ensure that the output of the tube voltage remains stable at the set voltage value.

The closed-loop processing of the tube current involves: the tube current of the X-ray tube is primarily controlled by the filament current of the X-ray tube. The variable filament power supply and the filament isolation transformer provide a constant current to the filament. Specifically, a reference current voltage is provided to the variable filament power supply to adjust its output current value, enabling a real-time adjustment of the filament current. The X-ray source microcontroller performs the PI algorithm based on the real-time sampled tube current to provide the reference voltage to the variable constant current source. Thus, the X-ray source microcontroller achieves PI-closed-loop control between the tube current and the reference voltage, enabling a stable tube current output.

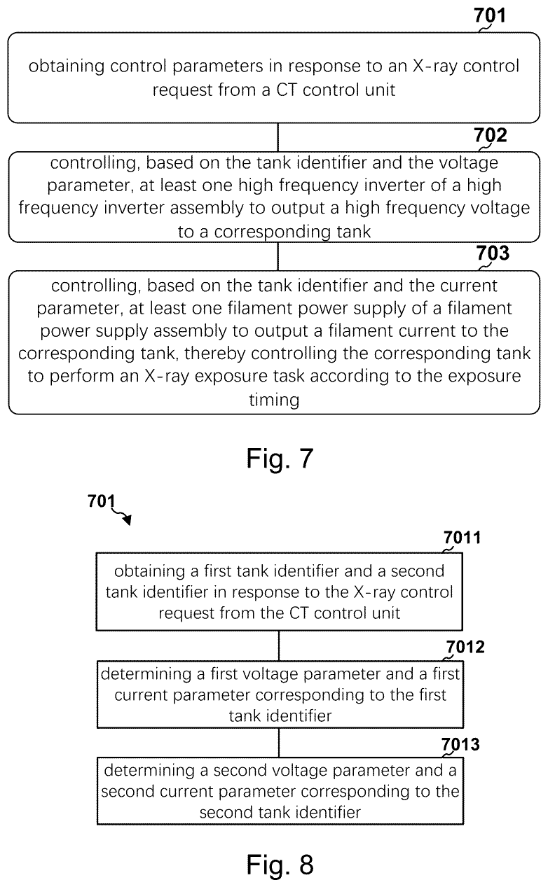

FIG. 7 illustrates a flowchart of the X-ray control method according to an embodiment of the present disclosure. The X-ray control method includes steps 701 to 703. The method may be executed by a CT apparatus or a CBCT apparatus.

In the step 701, control parameters are obtained in response to an X-ray control request from a CT control unit. The control parameters include at least one tank identifier, at least one voltage parameter, at least one current parameter, and at least one exposure timing.

It should be noted that the tank identifier refers to the unique identifier of each tank in the tank assembly. When the CT control unit issues the X-ray control request, the tank identifier in the request identifies which high frequency inverter and filament power supply the control parameters are intended to control.

The voltage parameter refers to the control parameter for the high frequency inverter. The current parameter refers to the control parameter for the filament power supply. The exposure timing refers to the timing sequence for coordinating the operation of multiple tanks and the drive signal mode for each tank.

The CT control unit, as the core controller of the CT system, receives user-input scan mode instructions (e.g., a bone-soft tissue separation mode, a metal artifact suppression mode, or a quantitative analysis mode) and automatically generates corresponding X-ray control requests based on preset clinical protocols. The control request includes multiple sets of X-ray source control parameters, such as tube voltage (kV) values, tube current (mA) values, exposure timing, X-ray on/off states, and tank identifiers for each tank 210, as well as parameters for the detector 500, including sampling timing, binning mode (pixel merging mode), and gain adjustment parameters. The generated X-ray control request is transmitted to the X-ray source microcontroller 300 via a CAN bus or SPI interface. The X-ray source microcontroller 300 parses the parameters and drives multiple independent high frequency inverters 121 of the high frequency inverter assembly 120 and multiple filament power supplies 131 of the filament power supply assembly 130, enabling each tank 210 to output X-rays of different energy spectra as needed.

In the step 702, based on the tank identifier and voltage parameter in the control parameters, at least one high frequency inverter of the high frequency inverter assembly is controlled to output a high frequency voltage to the corresponding tank.

Each high frequency inverter 121 in the high frequency inverter assembly 120 may adopt a full-bridge topology, capable of operating independently based on the tank identifier (e.g., ID1, ID2) and voltage parameter (e.g., 80 KV, 140 kV), converting a 380V high-voltage AC input from the power supply 110 into a high frequency AC voltage signal, and adjusting the duty cycle or frequency to match the target tube voltage value.

Each filament power supply 131 in the filament power supply assembly 130 dynamically adjusts its output current based on the tank identifier and current parameter (e.g., 5 mA, 10 mA). A closed-loop feedback control circuit monitors the filament current in real time via an ADC module and compensates for load variations, ensuring that the filament of the X-ray tube in each tank 210 is preheated to a target state, eliminating tube current fluctuations caused by space charge effects.

In the step 703, based on the tank identifier and current parameter in the control parameters, at least one filament power supply of the filament power supply assembly is controlled to output a filament current to the corresponding tank, thereby controlling the tank to perform an X-ray exposure task according to the exposure timing.

The X-ray source microcontroller 300, as the core control unit, communicates with the CT control unit via a serial port 422 or a serial port 232, receiving X-ray control parameters (e.g., a tube voltage, a tube current, an exposure timing) from the CT control unit and generating multiple independent drive signals to control each high frequency inverter 121 and filament power supply 131.

Based on the disclosed solution, the independent power supply and control of each tank 210 through a distributed multi-source architecture eliminate tube current fluctuations caused by voltage switching in traditional single-source dual-energy CT systems, improving tube current stability. The single-board integrated design of the high frequency inverter assembly 120 and the filament power supply assembly 130 significantly reduces system volume and weight, and supports modular expansion for dual-energy, tri-energy, or multi-energy spectrum output.

In one or more embodiments of the present disclosure, FIG. 8 illustrates a schematic diagram of a voltage and current control process according to an embodiment of the present disclosure. As shown in FIG. 8, the step 701 may include steps 7011 to 7013. In the step 7011, a first tank identifier and a second tank identifier are obtained in response to the X-ray control request from the CT control unit. In the step 7012, a first voltage parameter and a first current parameter corresponding to the first tank identifier are determined. In the step 7013, a second voltage parameter and a second current parameter corresponding to the second tank identifier are determined. The first voltage parameter and the first current parameter are used to control an output of a first tank, and the second voltage parameter and the second current parameter are used to control an output of a second tank.

If the first voltage parameter is different from the second voltage parameter, a first high frequency inverter is controlled to generate a first tube voltage based on the first voltage parameter, and a second high frequency inverter is controlled to generate a second tube voltage based on the second voltage parameter.

If the first voltage parameter is equal to the second voltage parameter, the first tube voltage generated by the first high frequency inverter is equal in magnitude to the second tube voltage generated by the second high frequency inverter.

If the first current parameter is different from the second current parameter, a first filament power supply is controlled to generate a first tube current based on the first current parameter, and a second filament power supply is controlled to generate a second tube current based on the second current parameter.

If the first current parameter is equal to the second current parameter, the first tube current generated by the first filament power supply is equal in magnitude to the second tube current generated by the second filament power supply.

Upon receiving a user's scan mode instruction (e.g., dual-energy or multi-energy spectrum mode), the CT control unit generates an X-ray control request containing multiple sets of X-ray source parameters based on preset clinical protocols. The request is transmitted to the X-ray source microcontroller 300 via a serial port 422 or a serial port 232. The request includes a first tank identifier (e.g., ID1) and a second tank identifier (e.g., ID2), along with corresponding voltage parameters (e.g., ID1 corresponds to 80 KV, ID2corresponds to 120 kV) and current parameters (e.g., ID1 corresponds to 5 mA, ID2 corresponds to 10 mA). The X-ray source microcontroller 300 parses the request and matches the corresponding control logic based on the uniqueness of the tank identifiers. For example, for ID1, the first high frequency inverter 121 in the high frequency inverter assembly 120 is activated, converting the 380V input from the power supply 110 into a high frequency AC voltage suitable for an 80 kV tube voltage, driving the primary winding of the high-voltage transformer in the corresponding tank 200. Simultaneously, the first filament power supply 131 in the filament power supply assembly 130 outputs a 5 mA current to the filament isolation transformer of the tank, ensuring the filament of the X-ray tube is preheated to a target state.

The control logic for the second tank identifier ID2 is completely independent of ID1's. The second high frequency inverter 121 in the high frequency inverter assembly 120 generates another high frequency AC voltage based on the 120 KV voltage parameter for ID2, driving the high-voltage transformer of the corresponding tank 200. The second filament power supply 131 outputs a 3 mA current to the filament isolation transformer of the corresponding tank. This distributed control architecture ensures that the voltage and current parameters of different tank components do not interfere with each other. For example, the 80 kV high-voltage output of ID1 is independently regulated by the first high frequency inverter 121, while the 120 kV high-voltage output of ID2 is independently controlled by the second high frequency inverter 121, with electrical isolation achieved through the single-board integrated design. Additionally, the X-ray source microcontroller 300 monitors the tube voltage, tube current, and temperature signals of each tank component in real time via an ADC module. Upon detecting an abnormality (e.g., overvoltage or overcurrent), protective actions are triggered only for the affected tank component, preventing fault propagation to other tank components.

If the first tank identifier (e.g., ID1) and the second tank identifier (e.g., ID2) have the same voltage parameter (e.g., both correspond to 80 kV) and current parameter (e.g., both correspond to 10 mA), the first voltage parameter equals the second voltage parameter, and the first current parameter equals the second current parameter. In this case, since each sub-tank has its own dedicated power supply circuit, even with identical voltage and current parameters, the high frequency inverter and filament power supply for each sub-tank independently generate the required tube voltage and tube current based on their respective voltage and current parameters, ensuring no mutual interference between sub-tanks.

Based on the disclosed solution, the unique matching of tank identifiers to independent voltage and current parameters enables synchronous X-ray emission across multiple energy spectra without dynamic voltage switching, eliminating tube current fluctuations caused by voltage switching in traditional dual-energy CT systems and enhancing tube current stability. The single-board integrated design of the high frequency inverter assembly 120 and filament power supply assembly 130 significantly reduces system volume and weight, while supporting modular expansion for dual-energy, tri-energy, or multi-energy spectrum output.

In one or more embodiments of the present disclosure, in response to a voltage change request for the first tank and/or the second tank, an independent first tube voltage is controlled while maintaining the first tube current constant, and an independent second tube voltage is controlled while maintaining the second tube current constant.

Upon receiving a voltage change request for the first tank and/or second tank (e.g., switching from bone-soft tissue separation mode to metal artifact suppression mode based on clinical needs), the CT control unit dynamically adjusts the X-ray source parameters according to the new scanning protocol. For example, if the first tank's tube voltage is set to 80 KV with a tube current of 5 mA, and the second tank's tube voltage is set to 120 KV with a tube current of 5 mA, the X-ray source microcontroller 300 parses the parameter request, identifying the tank identifiers (e.g., first tank ID1 and second tank ID2), and generates corresponding control signals. The first high frequency inverter 121 in the high frequency inverter assembly 120 adjusts the 380V input to a high frequency AC voltage suitable for 80 kV by modulating the duty cycle or frequency, driving the primary winding of the high-voltage transformer in the corresponding tank assembly 200. Simultaneously, the first filament power supply 131 maintains a 5 mA output. Similarly, the second tank corresponding to ID2 outputs the set 120 KV and 5 mA, achieving independent tube voltage adjustment while maintaining stable tube current.

Based on the disclosed solution, the independent high frequency inverters 121 in the high frequency inverter assembly 120 and filament power supplies 131 in the filament power supply assembly 130 allow for independent setting of tube voltage (kV) and tube current (mA) for each sub-tank 210 without interference. This decoupling effectively resolves the technical challenge of tube current fluctuations due to voltage switching in traditional single-source dual-energy CT systems.

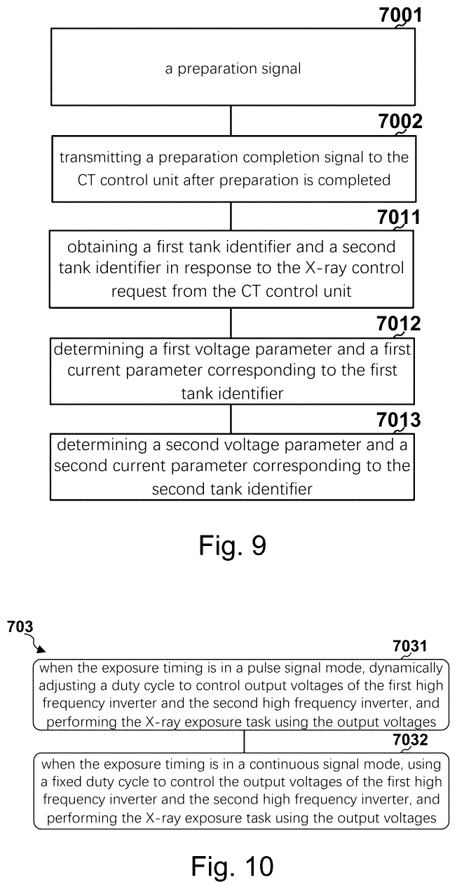

In one or more embodiments of the present disclosure, FIG. 9 illustrates a flowchart from preparation to execution of control according to an embodiment of the disclosure. As shown in FIG. 9, prior to the step 7011, the method includes steps 7001 and 7002. In the step 7001, a preparation signal is transmitted to the first high frequency inverter, the second high frequency inverter, the first filament power supply, and the second filament power supply, respectively. In the step 7002, a preparation completion signal is transmitted to the CT control unit after preparation is completed.

Before parsing the first tank identifier and the second tank identifier, the CT control unit sends voltage preparation signals to the first high frequency inverter 121 and the second high frequency inverter 121 in the high frequency inverter assembly 120, and current preparation signals to the first filament power supply 131 and the second filament power supply 131 in the filament power supply assembly 130. The voltage preparation signal triggers the high frequency inverter to enter a high-voltage output preparatory state, such as checking the stability of the 380V input voltage and ensuring that internal power devices are within normal operating temperature ranges. The current preparation signal initiates closed-loop feedback control for the filament power supply, monitoring the impedance characteristics of the filament heating circuit in real time via an ADC module to ensure rapid response to set current values.

Once the first high frequency inverter 121 completes self-checks of its voltage output channel (e.g., overvoltage protection circuit readiness, preset duty cycle for drive signals) and the first filament power supply 131 completes filament impedance matching (e.g., detecting whether the filament is short-circuited or open), the preparation results are fed back to the CT control unit via a serial port 422 or a serial port 232, indicating a “ready” state.

Similarly, the second high frequency inverter 121 and the second filament power supply 131 send feedback signals after completing their self-checks. The CT control unit proceeds to the X-ray control request parsing phase only after receiving ready signals from all components; otherwise, it triggers a fault diagnosis procedure and prompts the user to check the status of the corresponding tank component. For example, if the first filament power supply 131 detects a filament open-circuit anomaly, the CT control unit pauses the X-ray generation process, logs a fault code, and displays a prompt on the operation interface, such as “Sub-tank ID1 filament abnormality.”

Based on the disclosed solution, phased component self-checks and feedback confirmation significantly enhance system startup reliability. Specifically, the independent pre-check processes for high frequency inverters and filament power supplies can detect potential faults (e.g., high-voltage transformer short circuits, filament burnout) in advance, preventing imaging interruptions or equipment damage during the formal exposure phase.

In one or more embodiments of the present disclosure, FIG. 10 illustrates a flowchart of an X-ray exposure task execution mode according to an embodiment of the present disclosure. As shown in FIG. 10, step 703 may include: in the step 7031, when the exposure timing is in a pulse signal mode, dynamically adjusting a duty cycle to control output voltages of the first high frequency inverter and the second high frequency inverter, and performing the X-ray exposure task using the output voltages; and in the step 7032, when the exposure timing is in a continuous signal mode, using a fixed duty cycle to control the output voltages of the first high frequency inverter and the second high frequency inverter, and performing the X-ray exposure task using the output voltages.

Based on the drive signal mode specified by the exposure timing, the X-ray source microcontroller 300 generates corresponding control signals to drive the first high frequency inverter 121 and the second high frequency inverter 121, while coordinating the operating states of the first filament power supply 131 and the second filament power supply 131. Specifically, the drive signal modes include a pulse signal mode and a continuous signal mode.

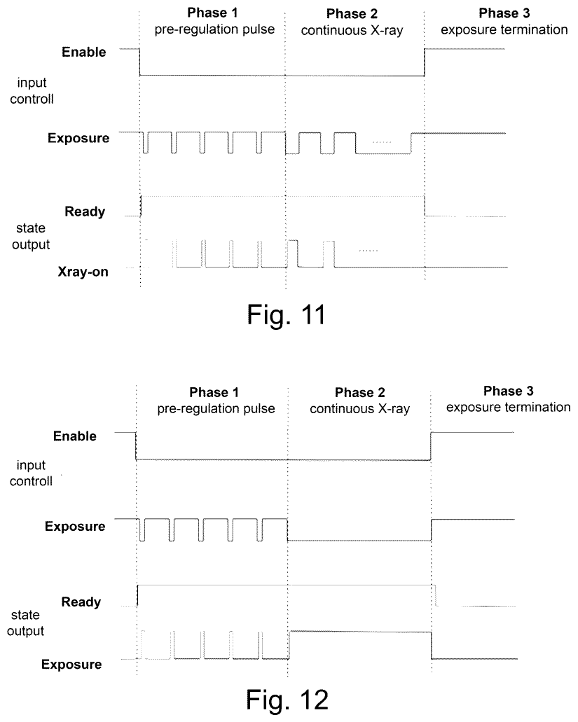

FIG. 11 illustrates a timing diagram of a pulse signal mode according to an embodiment of the present disclosure. In FIG. 11, the control input refers to the input signals provided by the CT control unit to the X-ray source microcontroller, including an enable signal (Enable) and an exposure timing signal (Exposure). The state outputs of the X-ray source microcontroller include an X-ray-on mode and a current preparation state of “ready.” The operation is divided into three phases. Phase 1 is the pre-regulation pulse phase at the start of enabling, during which the CT control unit sends control signals to the high frequency inverter assembly and the filament power supply assembly, and the X-ray source microcontroller feeds back a “ready” state signal. Phase 2 is the continuous X-ray phase, where the CT control unit issues pulse control signals, and X-rays are emitted in pulse mode. Phase 3 is the exposure termination phase, where the CT control unit stops outputting control signals, and the X-ray source microcontroller's ready state terminates.

In the pulse signal mode, the X-ray source microcontroller 300 dynamically controls the output characteristics of the high frequency inverters by adjusting the duty cycle, frequency, or phase difference of the pulse signals. For example, for the first high frequency inverter 121, the pulse signals generated by the X-ray source microcontroller 300 trigger the on/off switching of internal power devices (e.g., MOSFETs or IGBTs), converting the 380V input voltage into a high frequency AC voltage. The duty cycle of the pulse signal determines the amplitude of the output voltage (e.g., 80 kV corresponds to a 50% duty cycle, 100 kV corresponds to a 60% duty cycle), while the frequency is matched to the magnetic core characteristics of the high-voltage transformer to maximize energy transfer efficiency.

For the second high frequency inverter 121, the X-ray source microcontroller 300 can independently set another set of pulse parameters (e.g., 120 KV corresponds to a 70% duty cycle), achieving independent energy spectrum output for the two tank components. This control method is particularly suitable for dynamic exposure scenarios, such as adjusting tube voltage in real time based on detector feedback to optimize signal-to-noise ratio during CT scanning.

FIG. 12 illustrates a timing diagram of a continuous signal mode according to an embodiment of the present disclosure. The control input refers to the input signals provided by the CT control unit to the X-ray source microcontroller, including an enable signal (Enable) and an exposure timing signal (Exposure). The state outputs of the X-ray source microcontroller include an X-ray-on mode and a current preparation state of “ready.” The operation is divided into three phases. Phase 1 is the pre-regulation pulse phase at the start of enabling, during which the CT control unit sends control signals to the high frequency inverter assembly and the filament power supply assembly, and the X-ray source microcontroller feeds back a “ready” state signal. Phase 2 is the continuous X-ray phase, where the CT control unit issues continuous control signals, and X-rays are emitted in continuous mode. Phase 3 is the exposure termination phase, where the CT control unit stops outputting control signals, and the X-ray source microcontroller's ready state terminates.

In the continuous signal mode, the X-ray source microcontroller 300 outputs stable analog or digital control signals to maintain constant output voltages from the high frequency inverters. For example, the first high frequency inverter 121 receives a pulse signal with a fixed duty cycle (e.g., 60% duty cycle corresponds to 100 kV), driving the high-voltage transformer of the corresponding tank component to generate a stable high-voltage electric field. Simultaneously, the first filament power supply 131 maintains a constant 5 mA output through a closed-loop feedback circuit, ensuring consistent filament heating power for the X-ray tube.

The second high frequency inverter 121 and the second filament power supply 131 independently set their voltage parameter (e.g., 120 kV) and current parameter (e.g., 10 mA). The continuous signal mode is suitable for scenarios requiring stable long-term exposure (e.g., static three-dimensional imaging), significantly reducing the impact of tube voltage fluctuations on image quality.

Based on the disclosed solution, the flexible switching between pulse signal mode and continuous signal mode enables dynamic regulation and stable maintenance of high frequency inverter output characteristics. The pulse signal mode supports rapid dynamic adjustment of multi-energy spectrum X-rays (e.g., switching from dual-energy to tri-energy output). The continuous signal mode ensures tube voltage stability during prolonged exposure.

In one or more embodiments of the present disclosure, the method further includes: receiving a first tube voltage and a first tube current from the first tank, and receiving a second tube voltage and a second tube current from the second tank; monitoring, based on a voltage threshold, whether the first tube voltage and the second tube voltage are faulty; and monitoring, based on a current threshold, whether the first tube current and the second tube current are faulty.

When controlling the first tank and the second tank, the X-ray source microcontroller 300 receives real-time tube voltage and tube current data from each tank component and performs fault detection based on preset voltage and current thresholds. Specifically, the X-ray source microcontroller 300 stores overvoltage and undervoltage threshold ranges, as well as overcurrent and undercurrent threshold ranges, for different tank components. For example, the normal tube voltage range for the first tank is set to 75 kV to 85 kV (corresponding to a nominal 80 kV), and if the first tube voltage exceeds this range, an overvoltage or undervoltage fault is determined. If the first tube current deviates from the set value (e.g., 5 mA) by more than a ±5% threshold, an overcurrent or undercurrent fault signal is triggered.

For the second tank, the X-ray source microcontroller 300 uses independent threshold parameters (e.g., 115 kV to 125 kV voltage range, 10 mA ±5% current range), ensuring that fault detection logic for each tank is independent and non-interfering.

During fault detection, the X-ray source microcontroller 300 samples voltage and current signals in real time via an ADC module and calculates their mean and instantaneous values using a sliding window algorithm. For example, in pulse signal mode, the system periodically samples the input voltage of the primary winding of the high-voltage transformer in each tank and compares it to dynamically adjusted thresholds. If three consecutive sampling cycles detect a voltage exceeding the threshold, a fault protection action is triggered. If only a single transient fluctuation occurs, it is treated as noise and ignored. For current monitoring, the system integrates closed-loop feedback data from the filament power supply 131 and analyzes current change trends using a temperature rise slope calculation unit to avoid false positives due to temperature drift. When a fault is confirmed, the X-ray source microcontroller 300 immediately disables the drive signal of the corresponding high frequency inverter (e.g., the first high frequency inverter 121), sends a fault code to the CT control unit via a CAN bus, and displays specific error information on the operation interface (e.g., “First tank ID1 overvoltage fault”).

Based on the disclosed solution, the distributed threshold-based monitoring mechanism achieves high-precision fault detection for multi-energy spectrum X-ray systems, improving fault identification accuracy.

The X-ray source microcontroller 300 is further configured to perform closed-loop processing of the tube voltage and tube current to output a stable tube voltage and a stable tube current.

The closed-loop processing of the tube voltage and tube current refers to using Proportion Integral (PI) or Proportion Integral Differential (PID) algorithms.

Specifically, the closed-loop processing of the tube voltage involves: based on a set voltage value for the tube voltage and a sampled output voltage value, performing closed-loop control using a PI algorithm to ensure that the output tube voltage remains stable at the set voltage value.

The closed-loop processing of the tube current involves: the tube current of the X-ray tube is primarily controlled by the filament current of the filament. A variable filament power supply and a filament isolation transformer provide constant current to the filament. Specifically, a reference current voltage is provided to the variable filament power supply to adjust its output current value, enabling real-time adjustment. The X-ray source microcontroller performs the PI algorithm based on the real-time sampled tube voltage to provide the reference voltage to the variable constant current source. Thus, the X-ray source microcontroller implements PI-closed-loop control between the tube current and the reference voltage, ensuring stable tube current output.

In the disclosed solution, voltage and current are monitored independently, with separate threshold settings to avoid cross-interference common in traditional multi-source systems. For example, an overvoltage fault in the first tank does not affect the current detection logic of the second tank.

In an optional embodiment, the control parameters include N tank identifiers, where N is greater than or equal to 2. Each tank corresponds to one tank identifier, and each tank identifier corresponds one-to-one with a respective voltage parameter and a respective current parameter. Each additional tank represents an additional X-ray source, allowing users to operate in various combination modes without voltage switching, ensuring stable tube current. If any tank fails, the remaining tanks continue to operate normally.

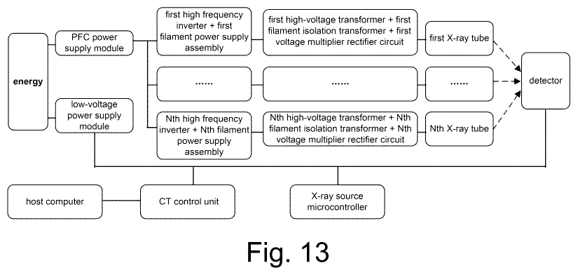

FIG. 13 illustrates a schematic structural diagram of a power supply system according to an embodiment of the present disclosure. As shown in FIG. 13, the mains power input is divided into two parts. The first part includes a Power Factor Correction (PFC) power supply module, which provides voltage and current to components generating X-rays. Specifically, each tank has its own dedicated high frequency inverter assembly and filament power supply assembly, e.g., a first high frequency inverter assembly and a first filament power supply assembly, up to a Nth high frequency inverter assembly and a Nth filament power supply assembly, where N is greater than or equal to 2, and the specific value of N may be selected based on requirements.

Each pair of high frequency inverter assembly and filament power supply assembly constitutes a combination circuit to power components such as the high-voltage transformer, filament isolation transformer, and voltage multiplier rectifier circuit in the corresponding tank. For example, the combination circuit of the first high frequency inverter assembly and the first filament power supply assembly provides tube voltage and tube current to the first high-voltage transformer, the first filament isolation transformer, and the first voltage multiplier rectifier circuit, enabling the first X-ray tube to generate the X-rays at a specified power level using the tube voltage and tube current. Similarly, the combination circuit of the Nth high frequency inverter assembly and the Nth filament power supply assembly provides tube voltage and tube current to the Nth high-voltage transformer, the Nth filament isolation transformer, and the Nth voltage multiplier rectifier circuit, enabling the Nth X-ray tube to generate the X-rays at a specified power level. In this scheme, multiple X-ray tubes can meet diverse power requirements without voltage switching, resulting in more stable X-ray generation. The second part is a low-voltage power supply module, which powers auxiliary components such as the CT control unit, X-ray source microcontroller, host computer, and detector. This circuit operates independently of the PFC power supply module, avoiding interference. Ultimately, the X-rays generated by multiple X-ray tubes are directed toward the detector.

The implementation details of the functions and roles of each module in the above-described apparatus correspond to the implementation processes of the corresponding steps in the method described above and are not repeated here.

In the description of this specification, references to terms such as “one embodiment,” “some embodiments,” “example,” “specific example,” or “some instances” indicate that specific features, structures, or characteristics described in connection with the embodiment or example are included in at least one embodiment or example of the present disclosure. In this specification, schematic references to such terms do not necessarily refer to the same embodiment or example. Furthermore, the specific features, structures, or characteristics described may be combined in any suitable manner in one or more embodiments or examples. Additionally, those skilled in the art may combine or integrate different embodiments or examples and their features described in this specification without contradiction.

Moreover, the terms “first” and “second” are used for descriptive purposes only and are not to be construed as indicating or implying relative importance or implicitly specifying the number of technical features indicated. Thus, a feature defined as “first” or “second” may explicitly or implicitly include at least one such feature. In the description of the present disclosure, “plurality” means at least two, such as two, three, or more, unless explicitly specified otherwise.

Those skilled in the art will appreciate that the embodiments described above are merely for clearly illustrating the present disclosure and are not intended to limit the scope of the present disclosure. Other variations or modifications may be made based on the above disclosure, and such variations or modifications remain within the scope of the present disclosure.

What is claimed is:

1. An X-ray control method executed by an X-ray source microcontroller in a CT apparatus, comprising:
obtaining control parameters in response to an X-ray control request from a CT control unit, wherein the control parameters comprise at least one tank identifier, at least one voltage parameter, at least one current parameter, and at least one exposure timing;
controlling, based on the tank identifier and the voltage parameter, at least one high frequency inverter of a high frequency inverter assembly to output a high frequency voltage to a corresponding tank of a plurality of tanks filled with insulating oil; and
controlling, based on the tank identifier and the current parameter, at least one filament power supply of a filament power supply assembly to output a filament current to the corresponding tank, thereby controlling the corresponding tank to perform an X-ray exposure task according to the exposure timing.

2. The method of claim 1, wherein obtaining the control parameters in response to the X-ray control request from the CT control unit comprises:
obtaining a first tank identifier and a second tank identifier in response to the X-ray control request; and
determining a first voltage parameter and a first current parameter corresponding to the first tank identifier, and determining a second voltage parameter and a second current parameter corresponding to the second tank identifier,
wherein the first voltage parameter and the first current parameter are used to control an output of a first tank, and the second voltage parameter and the second current parameter are used to control an output of a second tank.

3. The method of claim 2, wherein, when the first voltage parameter is different from the second voltage parameter, the method further comprises: controlling a first high frequency inverter to generate a first tube voltage based on the first voltage parameter, and controlling a second high frequency inverter to generate a second tube voltage based on the second voltage parameter.

4. The method of claim 3, wherein, when the first current parameter is different from the second current parameter, the method further comprises: controlling a first filament power supply to generate a first tube current based on the first current parameter, and controlling a second filament power supply to generate a second tube current based on the second current parameter.

5. The method of claim 4, prior to obtaining the first tank identifier and the second tank identifier, further comprising:
transmitting a preparation signal to the first high frequency inverter, the second high frequency inverter, the first filament power supply, and the second filament power supply, respectively; and
transmitting a preparation completion signal to the CT control unit after a preparation is completed.

6. The method of claim 4, wherein controlling the corresponding tank to perform the X-ray exposure task comprises:
when the exposure timing is in a pulse signal mode, dynamically adjusting a duty cycle to control output voltages of the first high frequency inverter and the second high frequency inverter, and performing the X-ray exposure task using the output voltages; and
when the exposure timing is in a continuous signal mode, using a fixed duty cycle to control the output voltages of the first high frequency inverter and the second high frequency inverter, and performing the X-ray exposure task using the output voltages.

7. The method of claim 4, further comprising:
receiving the first tube voltage and the first tube current from the first tank, and receiving the second tube voltage and the second tube current from the second tank; and
monitoring, based on a voltage threshold, whether the first tube voltage and the second tube voltage are faulty, and monitoring, based on a current threshold, whether the first tube current and the second tube current are faulty.

8. The method of claim 1, wherein the control parameters include N tank identifiers, where N≥2, the N tank identifiers correspond respectively to one tank of the plurality of tanks, and the N tank identifiers correspond one-to-one with respective voltage parameters and respective current parameters.

9. An X-ray control system, comprising:
a power supply module comprising a high frequency inverter assembly and a filament power supply assembly, wherein the high frequency inverter assembly and the filament power supply assembly are electrically connected to a power supply, the high frequency inverter assembly comprises a plurality of high frequency inverters that are independently operating, and the filament power supply assembly comprises a plurality of filament power supplies that are independently operating;
a tank assembly comprising a plurality of tanks that are filled with insulating oil and are independently operating, wherein each of the plurality of tanks is configured to generate X-rays under a control of a pair of one high frequency inverter and one filament power supply; and
an X-ray source microcontroller configured to:
receive control parameters in response to an X-ray control request, wherein the control parameters comprise at least one tank identifier, at least one voltage parameter, at least one current parameter, and at least one exposure timing;
control, based on the tank identifier and the voltage parameter, at least one high frequency inverter of the high frequency inverter assembly to output a high frequency voltage to a tank of the plurality of tanks, and
control, based on the tank identifier and the current parameter, at least one filament power supply of the filament power supply assembly to output a filament current to the tank, thereby controlling the tank to perform an X-ray exposure task according to the exposure timing.

10. The X-ray control system of claim 9, further comprising a CT control unit that is configured to generate the X-ray control request in response to a control instruction from a user and transmit the X-ray control request to the X-ray source microcontroller.

11. The X-ray control system of claim 9, further comprising a detector that is configured to receive the X-rays generated by the tank assembly and convert the X-rays into grayscale values for generating a visible image.

12. The X-ray control system of claim 11, wherein each of the plurality of high frequency inverters is connected to the power supply to receive an input voltage, and is connected to the X-ray source microcontroller to receive a voltage control signal.

13. The X-ray control system of claim 12, wherein each of the plurality of filament power supplies is connected to the power supply to receive the input voltage, and is connected to the X-ray source microcontroller to receive a current control signal.

14. The X-ray control system of claim 13, wherein each of the plurality of tanks comprises:
a high-voltage transformer configured to generate a tube voltage after receiving the voltage control signal;
a filament isolation transformer configured to generate a tube current after receiving the current control signal;
an X-ray tube configured to generate the X-rays;
a voltage multiplier rectifier circuit configured to convert a high-voltage, high frequency AC voltage of into positive and negative high voltages supplied to the X-ray tube; and
a sampling circuit configured to collect the positive and negative high voltages and the tube current.

15. The X-ray control system of claim 11, wherein the plurality of tanks are arranged around the detector, with X-ray emission angles of the plurality of tanks directed toward the detector.

16. The X-ray control system of claim 9, wherein the power supply module, the filament power supply assembly, the high frequency inverter assembly, the tank assembly, and the X-ray source microcontroller are integrated into a single module.

17. The X-ray control system of claim 14, wherein the X-ray source microcontroller further receives the tube voltage and the tube current from each of the plurality of tanks, and monitors whether the X-ray control system is faulty based on the tube voltage and the tube current.

18. The X-ray control system of claim 17, wherein the X-ray source microcontroller further performs a closed-loop processing of the tube voltage and the tube current to output a stable tube voltage and a stable tube current.

19. A CT apparatus comprising the X-ray control system of claim 9.
